(19) United States
(12) Patent Application Publication
(10) Pub. No.: US 2026/0238576 A1
(43) Pub. Date: Aug. 13, 2026

(54) APPARATUS AND METHOD FOR SETTING MESSAGE RECEPTION TIMEOUT FOR DISTRIBUTED CONSENSUS

(71) Applicant: ELECTRONICS AND TELECOMMUNICATIONS RESEARCH INSTITUTE, Daejeon (KR)

(72) Inventors: Young-Chang KIM, Daejeon (KR); Sung-Jin MOON, Daejeon (KR); Min-Jae SEO, Daejeon (KR); Jin-Tae OH, Daejeon (KR); Jong-Choul YIM, Daejeon (KR)

(73) Assignee: ELECTRONICS AND TELECOMMUNICATIONS RESEARCH INSTITUTE, Daejeon (KR)

(21) Appl. No.: 19/402,118

(22) Filed: Nov. 26, 2025

(30) Foreign Application Priority Data
Feb. 11, 2025 (KR) 10-2025-0017439

(51) Int. Cl. H04L 43/0852

(52) U.S. Cl. CPC H04L 43/0852

(57) ABSTRACT

Disclosed herein are an apparatus and method for setting message reception timeout for distributed consensus. The apparatus for setting message reception timeout for distributed consensus may be configured to measure reception latency of a message for each consensus stage in a consensus protocol of a blockchain system, calculate an exponential moving average using the measured reception latency and a previously calculated exponential moving average, calculate a timeout value for the reception latency based on the exponential moving average, and distribute the calculated timeout value to all nodes.

### CROSS REFERENCE TO RELATED APPLICATION

This application claims the benefit of Korean Patent Application No. 10-2025-0017439, filed Feb. 11, 2025, which is hereby incorporated by reference in its entirety into this application.

### BACKGROUND OF THE INVENTION

### 1. Technical Field

The present disclosure relates generally to a blockchain-based distributed consensus technology, and more particularly to a technology for setting message reception timeout for distributed consensus.

### 2. Description of the Related Art

In a blockchain network, when a congress composed of 3f+1 nodes experiences a node failure during block consensus, a failed node may be replaced to form a new congress, and a consensus process may be resumed. Determination of a node failure is performed using a fixed timeout value that is preset during a consensus process. That is, unless a consensus message is received from the corresponding node within a message reception timeout, the corresponding node is determined to have failed. Here, because node failure is determined based on a preset timeout without considering changes in network topology or load caused by changes in nodes connected to a blockchain network, the following problems may occur. First, when message delivery latency (delay time) increases, a normal node may be determined to have failed. Second, when the set timeout is excessively long, determination of a node failure is delayed during the corresponding time, thus influencing the performance of consensus.

Also, transaction throughput may be optimized by setting target latency in the blockchain network, measuring actual latency, adjusting a block size based on a comparison between the target latency and the measured latency, and adjusting the number of virtual Central Processing Units (vCPUs) and the number of channels, when the target latency is not maintained. However, because a block is filled with transactions and latency for a process of completing a consensus process is measured and used, there is a disadvantage in that the latency cannot be used as a factor for determining a node failure when consensus messages between nodes are exchanged in each consensus stage during block consensus.

Meanwhile, U.S. Pat. No. 11,625,260 entitled “Method for enhancing throughput in blockchain network” discloses a method for optimizing transaction throughput by adjusting a block size or a hardware resource through a comparison between target latency and actual latency in a blockchain network.

### SUMMARY OF THE INVENTION

Accordingly, the present disclosure has been made keeping in mind the above problems occurring in the prior art, and an object of the present disclosure is to set a timeout value used to determine a node failure during a block consensus process in consideration of the changed state of a blockchain network.

Another object of the present disclosure is to reflect recent changes in network and exclude outlier values from latencies measured by respective nodes.

A further object of the present disclosure is to prevent an error in which a normal node is determined to have failed during a consensus process and to rapidly detect a node in which an actual failure has occurred.

In accordance with an aspect of the present disclosure to accomplish the above objects, there is provided an apparatus for setting message reception timeout for distributed consensus, including one or more processors, and a memory configured to store at least one program that is executed by the one or more processors, wherein the at least one program is configured to measure reception latency of a message for each consensus stage in a consensus protocol of a blockchain system, calculate an exponential moving average using the measured reception latency and a previously calculated exponential moving average, calculate a timeout value for the reception latency based on the exponential moving average, and distribute the calculated timeout value to all nodes.

Here, the at least one program may be configured to calculate the exponential moving average by applying a preset weight ratio to the reception latency and the previously calculated exponential moving average.

Here, the at least one program may be configured to calculate the timeout value from a sum of an average of exponential moving averages received from congress nodes of the blockchain system and a standard deviation of the exponential moving averages.

Here, the at least one program may be configured to measure the reception latency of the message by starting and stopping a timer for each consensus stage in the consensus protocol.

Here, the at least one program may be configured to allow a chair node to measure reception latencies of a delegate request message and a commit message, and allow a congress node to measure reception latencies of a prepare message and a committed message.

Here, the at least one program may be configured to deliver a candidate block, together with the timeout value, to all congress nodes through a prepare message and generate a final block through a commit message.

Here, the at least one program may be configured to share an exponential moving average calculated for each consensus stage in the consensus protocol among congress members, and update the timeout value at each preset block period.

In accordance with another aspect of the present disclosure to accomplish the above objects, there is provided a method for setting message reception timeout for distributed consensus, performed by an apparatus for setting message reception timeout for distributed consensus, the method including measuring reception latency of a message for each consensus stage in a consensus protocol of a blockchain system; calculating an exponential moving average using the measured reception latency and a previously calculated exponential moving average; calculating a timeout value for the reception latency based on the exponential moving average; and distributing the calculated timeout value to all nodes.

Here, calculating the exponential moving average may include calculating the exponential moving average by applying a preset weight ratio to the reception latency and the previously calculated exponential moving average.

Here, calculating the timeout value may include calculating the timeout value from a sum of an average of exponential moving averages received from congress nodes of the blockchain system and a standard deviation of the exponential moving averages.

Here, measuring the reception latency may include measuring the reception latency of the message by starting and stopping a timer for each consensus stage in the consensus protocol.

Here, measuring the reception latency may further include measuring, by a chair node, reception latencies of a delegate request message and a commit message, and measuring, by a congress node, reception latencies of a prepare message and a committed message.

Here, distributing the calculated timeout value may include delivering a candidate block, together with the timeout value, to all congress nodes through a prepare message and generating a final block through a commit message.

Here, distributing the calculated timeout value may include sharing an exponential moving average calculated for each consensus stage in the consensus protocol among congress members, and updating the timeout value at each preset block period.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a distributed consensus process according to an embodiment of the present disclosure;

FIG. 2 is a diagram illustrating a process in which each node measures message sending/reception latency according to an embodiment of the present disclosure;

FIG. 3 is a diagram illustrating a process of calculating an exponential moving average using measured latency according to an embodiment of the present disclosure;

FIG. 4 is a diagram illustrating a process of setting a new timeout value according to an embodiment of the present disclosure;

FIG. 5 is an operation flowchart illustrating a method for setting message reception timeout for distributed consensus according to an embodiment of the present disclosure;

FIG. 6 is an operation flowchart illustrating in detail an example of the reception latency measurement step and the exponential moving average calculation step illustrated in FIG. 5;

FIG. 7 is an operation flowchart illustrating in detail an example of the timeout value calculation step and the timeout value distribution step illustrated in FIG. 5; and

FIG. 8 is a diagram illustrating a computer system according to an embodiment of the present disclosure.

### DESCRIPTION OF THE PREFERRED EMBODIMENTS

The present disclosure will be described in detail with reference to the attached drawings. Repeated descriptions and descriptions of known functions and configurations which have been deemed to make the gist of the present disclosure unnecessarily obscure will be omitted below. The embodiments of the present disclosure are provided to more fully describe the present disclosure to those skilled in the art. Therefore, the shapes, sizes, etc. of elements in the drawings may be exaggerated for clear illustration.

In the entire specification, when a certain element is described as “comprising” or “including” a specific component, it means that, unless explicitly stated otherwise, the certain element may further include additional components without excluding the additional components.

The present disclosure may be variously modified and may have various embodiments, and the embodiments are intended to be illustrated and described in detail in the accompanying drawings.

However, this is not intended to limit the present disclosure to particular embodiments, and it should be appreciated that all changes, equivalents, and substitutes that do not depart from the spirit and technical scope of the present disclosure are encompassed in the present disclosure.

In description of components of the embodiment of the present disclosure, terms such as first, second, A, B, (a), and (b) may be used. These terms are used merely to distinguish one component from other components, and the essentials, order, or sequence of the components are not limited by the terms.

Unless otherwise defined, all terms including technical and scientific terms used herein have the same meaning as commonly understood by one of ordinary skill in the art to which the present disclosure belongs. Terms that are generally defined in commonly used dictionaries should be construed as having meanings consistent with their contextual usage in the relevant technical field, and, unless explicitly defined in this application, and should not be construed in an idealized or unduly formal sense.

It will be understood that when a component is referred to as being “associated” with another component, it can be directly associated with or connected to the other component, but other intervening components may be present therebetween.

The terms used in the present disclosure are used only to describe a specific embodiment, and are not intended to limit the present disclosure. A singular expression includes a plural expression unless a description to the contrary is specifically pointed out in context. It will be further understood that the terms “comprise”, “include”, “have”, etc. when used in this specification, specify the presence of stated features, numbers, steps, operations, elements, or combinations thereof but do not preclude the possibility of the presence or addition of one or more other features, numbers, steps, operations, elements, or combinations thereof.

Hereinafter, embodiments of the present disclosure will be described in detail with reference to the attached drawings. In the description of the present disclosure, independent reference numerals are used to designate the same components in the drawings to facilitate overall understanding.

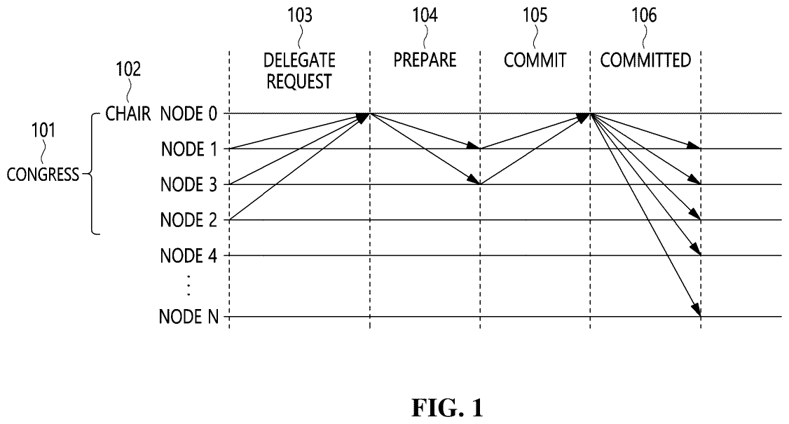

FIG. 1 is a diagram illustrating a distributed consensus process according to an embodiment of the present disclosure.

Referring to FIG. 1, when a new block consensus is initiated, a congress (i.e., consensus group) 101 for reaching consensus for a corresponding block may be formed.

Here, a node having the highest priority may function as a chair node (i.e., a leader node or a primary node) 102.

Here, when a consensus is initiated, each congress node 101 may send a delegate request message including the transaction to be agreed upon in the block to the chair node 102 (in stage 103).

When the number of received delegate request messages is 2f+1, the chair node 102 may generate a candidate block using the submitted transactions, and may send prepare messages to 2f+1 congress nodes 101 (in stage 104).

The congress nodes 101 that have received the prepare messages may verify the candidate block received through the prepare messages, and may deliver commit messages to the chair node 102 when verification is completed (in stage 105).

When all commit messages have been received, the chair node 102 may generate a final block and deliver the final block to all nodes through committed messages (in stage 106).

Here, in each consensus stage, a message reception timeout is defined. When a consensus message is not received from a node within the corresponding timeout, the node may be considered to have failed.

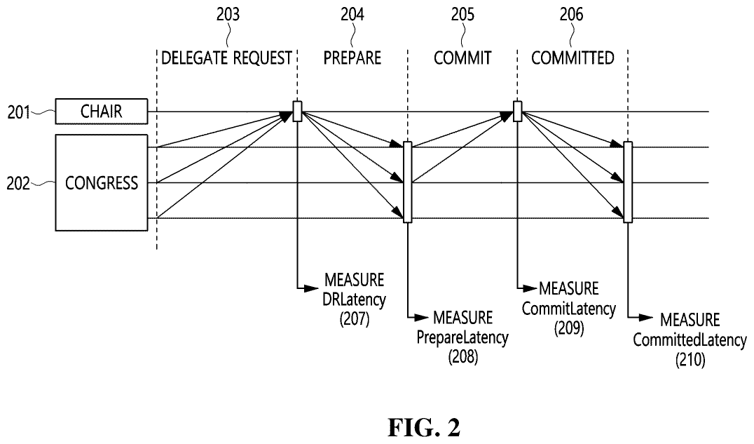

FIG. 2 is a diagram illustrating a process in which each node measures message sending/reception latency according to an embodiment of the present disclosure.

Referring to FIG. 2, in the distributed consensus process described with reference to FIG. 1, a chair node 201 and each congress node 202 may measure message reception latency for each consensus stage depending on the role of congress in each consensus stage.

When an i-th new block consensus is initiated, the chair node 201 may start a delegate request timer (DRTimer) so as to measure the reception latency of a delegate request message (in stage 203).

Each congress node 202 may send the delegate request message to the chair node 201, and may start a prepare timer (PrepareTimer) for measuring the reception latency of a prepare message (in stage 204).

When 2f+1 delegate request messages have been received from the congress nodes 202 including the chair node 201 itself, the chair node 201 may stop the DRTimer and store the measured delegate request latency (DRLatency) 207.

Further, the chair node 201 may send prepare messages to 2f+1 congress nodes 202 including itself, and may start a commit timer (CommitTimer) for measuring the reception latency of commit messages (in stage 205).

When receiving the corresponding prepare message, each of the 2f+1 congress nodes 202 may stop the PrepareTimer, and may store the measured prepare latency (PrepareLatency) 208.

Also, each of the congress nodes 202 may send a commit message to the chair node 201, and may start a committed timer (CommittedTimer) for measuring the reception latency of a committed message (in stage 206).

When all commit messages have been received, the chair node 201 may stop the CommitTimer, and may store the measured commit latency (CommitLatency) 209.

The chair node 201 may transmit a final block through the committed messages, and the congress nodes that have received the final block may stop the committed timer (CommittedTimer), and may store the measured committed latency (CommittedLatency) 210.

Consequently, when the consensus for the corresponding block is completed, the chair node 201 stores the DRLatency and the CommitLatency as i-th latencies, and each of the congress nodes 202 may store the PrepareLatency and the CommittedLatency as i-th latencies.

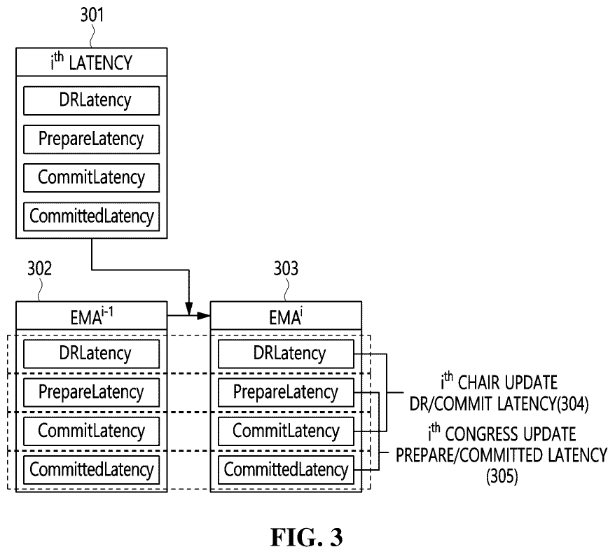

FIG. 3 is a diagram illustrating a process of calculating an exponential moving average using measured latency according to an embodiment of the present disclosure.

Referring to FIG. 3, when i-th block consensus is completed in FIG. 2, each congress node may store i-th latency (i^{th} Latency) 301 for each consensus stage.

After the i-th latency is stored, each congress node may calculate an i-th exponential moving average 303 using a previously calculated i−1-th exponential moving average 302 and the i-th latency 301.

The Exponential Moving Average (EMA) may be calculated using the following Equation (1) for each consensus stage.

$$E M {A}^{i} = {Latency}^{i} \times a + E M {A}^{i - 1} \times ( 1 - a ) \qquad ( 1 )$$

In Equation (1), ‘a’ is a value less than 1, and indicates a weight ratio to the most recently measured latency.

Here, because the measured message latencies differ depending on the role in the block consensus stage, each item of EMAⁱ may be calculated depending on the role. The chair node may calculate and update the DRLatency and the CommitLatency (in stage 304), and each congress node may calculate and update the PrepareLatency and the CommittedLatency (in stage 305).

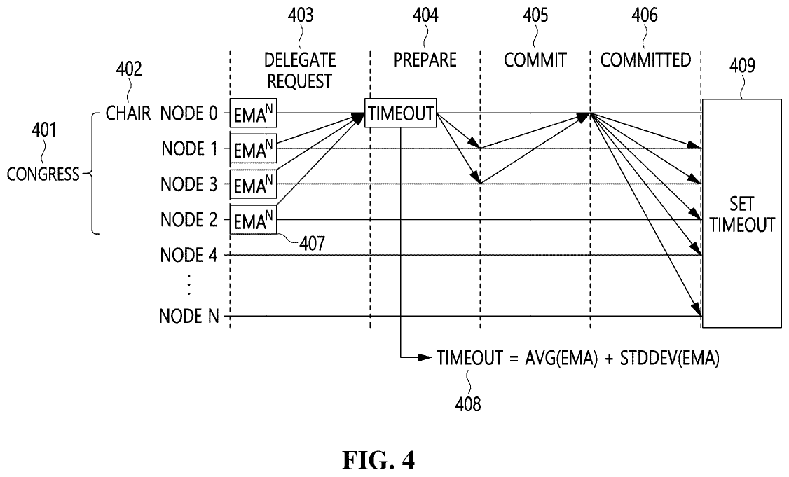

FIG. 4 is a diagram illustrating a process of setting a new timeout value according to an embodiment of the present disclosure.

Referring to FIG. 4, it can be seen that a process of calculating a timeout using latencies measured through block consensus and setting a new timeout value according to an embodiment of the present disclosure is illustrated.

In FIG. 4, when exponential moving averages are calculated, respective congress nodes may submit the exponential moving averages measured by the corresponding congress nodes in the corresponding block consensus process at each preset block period.

Each congress node may determine a timeout value to be newly set using the exponential moving averages submitted in the consensus process, and may distribute the determined timeout value to all nodes through the committed block.

First, when the consensus for block N corresponding to a preset block period is initiated, each of congress nodes 401 including a chair node 402 may transmit its own exponential moving average EMA^{N} 407 to the chair node 402 through a delegate request message (in stage 403).

The chair node 402 may calculate the timeout based on the equation TIMEOUT=AVG(EMA)+STDDEV(EMA) using submitted EMA^{N} of respective nodes (in stage 408).

AVG(EMA) denotes the average of EMA^{N} submitted by respective nodes, and STDDEV(EMA) denotes the standard deviation of EMA^{N}.

The chair node 402 may deliver the calculated timeout value TIMEOUT, together with a candidate block, to 2f+1 congress members through prepare messages (in stage 404).

The congress members 401 that have received the prepare messages may verify the candidate block and the TIMEOUT, and thereafter deliver commit messages to the chair node 402 (in stage 405).

The chair node 402 may generate a final block, and may deliver the final block and the TIMEOUT to all nodes through committed messages (in stage 406).

All nodes that have received the committed messages (Committed) may set a new timeout value TIMEOUT (in stage 409).

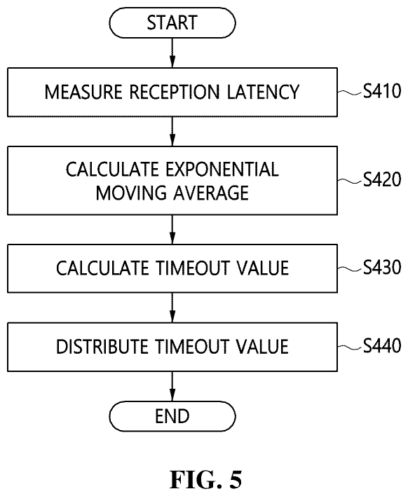

FIG. 5 is an operation flowchart illustrating a method for setting message reception timeout for distributed consensus according to an embodiment of the present disclosure.

Referring to FIG. 5, the method for setting message reception timeout for distributed consensus according to the embodiment of the present disclosure may first measure reception latency at step S410.

That is, at step S410, reception latency of a message for each consensus stage in a consensus protocol of a blockchain system may be measured.

Here, at step S410, the reception latency of each message may be measured by starting and stopping the timer for each consensus stage in the consensus protocol.

Here, at step S410, a chair node may measure the reception latencies of a delegate request message and a commit message, and each congress node may measure the reception latencies of a prepare message and a committed message.

In addition, the method for setting message reception timeout for distributed consensus according to the embodiment of the present disclosure may calculate an exponential moving average at step S420.

That is, at step S420, the exponential moving average may be calculated using the measured reception latency and a previously calculated exponential moving average.

Here, at step S420, the exponential moving average may be calculated by applying a preset weight ratio to the reception latency and the previously calculated exponential moving average.

Further, the method for setting message reception timeout for distributed consensus according to the embodiment of the present disclosure may calculate a timeout value at step S430.

That is, at step S430, the timeout value for the reception latency may be calculated based on the exponential moving average.

Here, at step S430, the timeout value may be calculated from the sum of the average of the exponential moving averages received from congress nodes of the blockchain system and the standard deviation of the exponential moving averages.

Furthermore, the method for setting message reception timeout for distributed consensus according to the embodiment of the present disclosure may distribute the timeout value at step S440.

That is, step S440 includes the step of distributing the calculated timeout value to all nodes.

Here, at step S440, a candidate block, together with the timeout value, may be delivered to all congress nodes through prepare messages, and a final block may be generated (i.e., the block may be finalized) through commit messages.

Here, at step S440, the exponential moving averages calculated for each consensus stage of the consensus protocol may be shared among the members of the congress, and the timeout value may be updated at each preset block period.

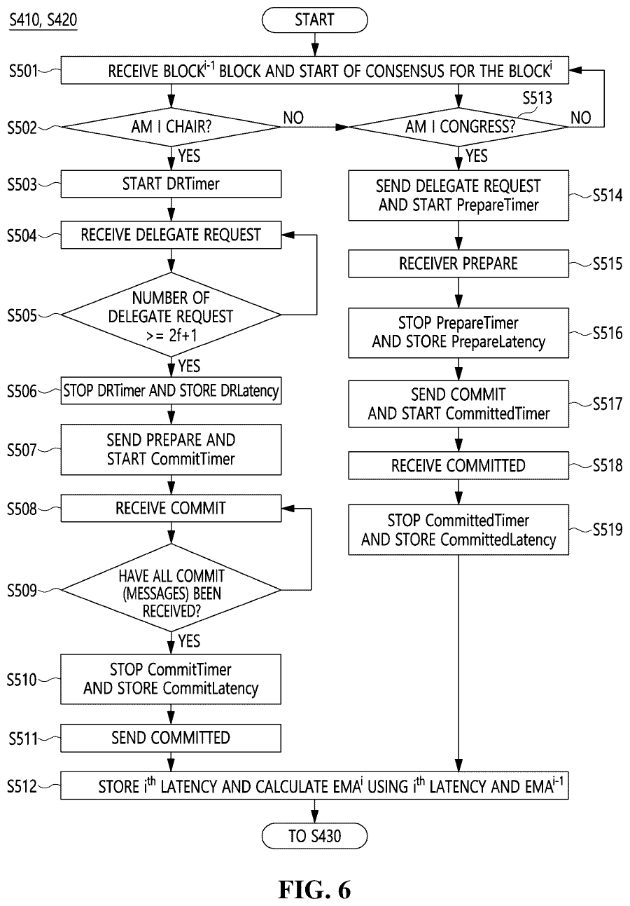

FIG. 6 is an operation flowchart illustrating in detail an example of the reception latency measurement step and the exponential moving average calculation step illustrated in FIG. 5.

Referring to FIG. 6, when receiving an i−1-th committed final block, each node in a blockchain network may initiate a consensus for an i-th new block at step S501.

Each node may check whether it is the chair of the congress at step S502.

Here, when it is determined at step S502 that the corresponding node is the chair node, a delegate request timer (DRTimer) may be started to measure the reception latency of a delegate request message at step S503.

The chair node may receive the delegate request message at step S504.

The chair node may check whether 2f+1 messages, which constitute the quorum for consensus, have been received at step S505.

When the 2f+1 messages, which constitute the quorum for consensus, have been received, the chair node may stop the DRTimer and store the measured DRLatency at step S506.

The chair node may send prepare messages to 2f+1 congress members including itself, and may start a commit timer (CommitTimer) for measuring the reception latency of commit messages at step S507.

The chair node may receive commit messages at step S508.

The chair node may check whether all commit messages have been received at step S509. When all commit messages have been received, the chair node may stop the CommitTimer and store the measured CommitLatency at step S510.

The chair node may send a final block through committed messages at step S511.

Finally, the chair node may calculate an i-th exponential moving average EMAⁱ using the stored i-th block latency and a previously calculated exponential moving average EMAⁱ⁻¹, and may store the EMAⁱ at step S512.

Also, when the corresponding node is not a chair node at step S502, whether the corresponding node is a congress node may be checked at step S513.

When the corresponding node is a congress node at step S513, the congress node may send a delegate request message to the chair node, and may start a prepare timer (PrepareTimer) for measuring the reception latency of a prepare message at step S514.

The congress node may receive the prepare message at step S515.

The congress node may stop the PrepareTimer and store the measured PrepareLatency at step S516.

The congress node may send a commit message to the chair node, and may start a committed timer (CommittedTimer) for measuring the reception latency of a committed message at step S517.

The congress node may receive the committed message at step S518.

The congress node may stop the CommittedTimer and store the measured CommittedLatency at step S519.

Finally, the congress node may calculate an i-th exponential moving average EMAⁱ using the stored i-th block latency and the previously calculated exponential moving average EMAⁱ⁻¹, and may store the EMAⁱ at step S512.

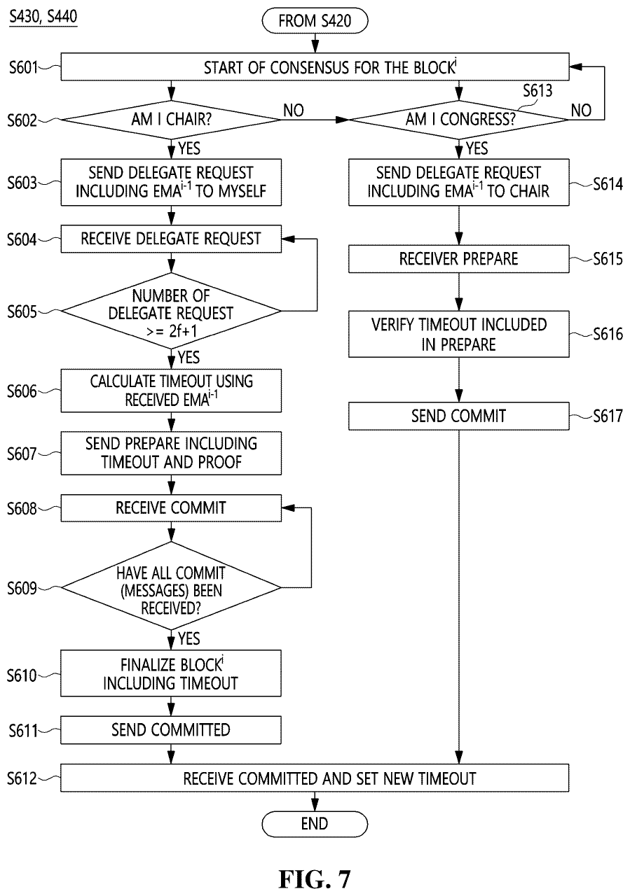

FIG. 7 is an operation flowchart illustrating in detail an example of the timeout value calculation step and the timeout value distribution step illustrated in FIG. 5.

Referring to FIG. 7, a procedure is illustrated in which timeout is calculated using latency measured through block consensus according to an embodiment and a new timeout value is set.

When exponential moving averages stored by respective nodes of congress are calculated depending on the procedure described in FIG. 6, the exponential moving averages measured by respective nodes in a consensus process for the corresponding block at each preset block period may be submitted, and the timeout value to be newly set may be determined using the exponential moving averages submitted in the consensus process, and may be distributed to all nodes through the committed block. Further, all nodes that have received the distributed block may set a new message reception timeout to the value included in the block.

First, the consensus for block i corresponding to a preset block period may be initiated at step S601.

Each node may check whether it is the chair node of congress at step S602.

Here, when the corresponding node is the chair node at step S602, the chair node may send a delegate request message including its own EMAⁱ⁻¹ to itself as the chair at step S603.

The chair node may receive the delegate request message at step S604.

The chair node may check whether 2f+1 messages, which constitute the quorum for consensus, have been received at step S605.

When the 2f+1 messages, which constitute the quorum for consensus, have been received, the chair node may calculate a new timeout value (TIMEOUT) by calculating average+standard deviation using EMAⁱ⁻¹ values submitted by respective congress nodes at step S606.

The chair node may deliver the calculated TIMEOUT and proof, together with a candidate block, to 2f+1 congress members through prepare messages at step S607. The chair node may receive commit messages at step S608.

The chair node may check whether all commit messages have been received at step S609.

When all commit messages have been received, the chair node may generate a final block including the TIMEOUT (i.e., finalize the block including the TIMEOUT) at step S610.

The chair node may deliver the final block to all nodes through committed messages at step S611.

All nodes that have received the committed messages (Committed) may set a new timeout value (TIMEOUT) at step S612.

Furthermore, when the corresponding node is not a chair node at step S602, whether the corresponding node is a congress node may be checked at step S613.

When the corresponding node is a congress node, the congress node may send a delegate request message including its own EMAⁱ⁻¹ to the chair node at step S614.

The congress node may receive a prepare message at step S615.

The congress node may verify the candidate block and the TIMEOUT at step S616.

When verification is completed, the congress node may deliver a commit message to the chair node at step S617.

All nodes that have received the committed messages (Committed) may set the new TIMEOUT at step S612.

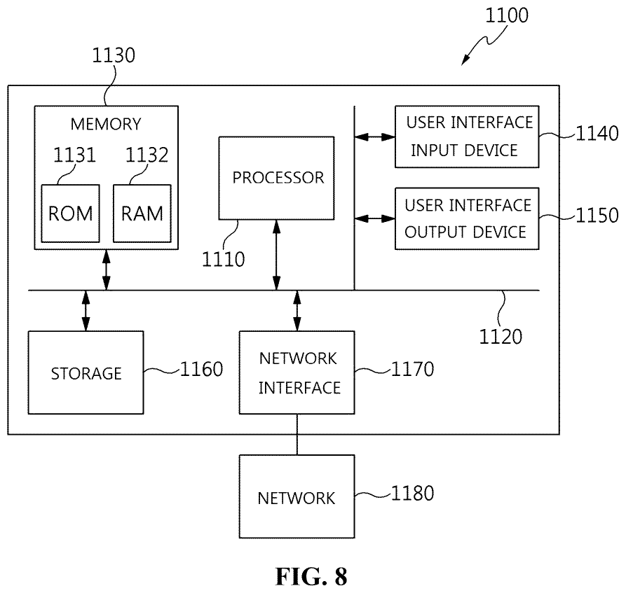

FIG. 8 is a diagram illustrating a computer system according to an embodiment of the present disclosure.

Referring to FIG. 8, an apparatus for setting message reception timeout for distributed consensus according to an embodiment of the present disclosure and all nodes of a blockchain system may be implemented in a computer system 1100 such as a computer-readable storage medium. As illustrated in FIG. 8, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

An apparatus for setting message reception timeout for distributed consensus according to an embodiment of the present disclosure may include one or more processors 1110, and a memory 1130 configured to store at least one program that is executed by the one or more processors 1110, wherein the at least one program is configured to measure reception latency of a message for each consensus stage in a consensus protocol of a blockchain system, calculate an exponential moving average using the measured reception latency and a previously calculated exponential moving average, calculate a timeout value for the reception latency based on the exponential moving average, and distribute the calculated timeout value to all nodes.

Here, the at least one program may be configured to calculate the exponential moving average by applying a preset weight ratio to the reception latency and the previously calculated exponential moving average.

Here, the at least one program may be configured to calculate the timeout value from a sum of an average of exponential moving averages received from congress nodes of the blockchain system and a standard deviation of the exponential moving averages.

Here, the at least one program may be configured to measure the reception latency of the message by starting and stopping a timer for each consensus stage in the consensus protocol.

Here, the at least one program may be configured to allow a chair node to measure reception latencies of a delegate request message and a commit message, and allow a congress node to measure reception latencies of a prepare message and a committed message.

Here, the at least one program may be configured to deliver a candidate block, together with the timeout value, to all congress nodes through a prepare message and generate a final block through a commit message.

Here, the at least one program may be configured to share an exponential moving average calculated for each consensus stage in the consensus protocol among congress members, and update the timeout value at each preset block period.

The present disclosure may set a timeout value used to determine a node failure during a block consensus process in consideration of the changed state of a blockchain network.

Further, the present disclosure may reflect recent changes in network and exclude outlier values from latencies measured by respective nodes.

Furthermore, the present disclosure may prevent an error in which a normal node is determined to have failed during a consensus process and to rapidly detect a node in which an actual failure has occurred.

As described above, in the apparatus and method for setting message reception timeout for distributed consensus according to embodiments of the present disclosure, the configurations and schemes in the above-described embodiments are not limitedly applied, and some or all of the above embodiments can be selectively combined and configured such that various modifications are possible.

What is claimed is:

1. An apparatus for setting message reception timeout for distributed consensus, comprising:
one or more processors; and
a memory configured to store at least one program that is executed by the one or more processors,
wherein the at least one program is configured to:
measure reception latency of a message for each consensus stage in a consensus protocol of a blockchain system,
calculate an exponential moving average using the measured reception latency and a previously calculated exponential moving average,
calculate a timeout value for the reception latency based on the exponential moving average, and
distribute the calculated timeout value to all nodes.

2. The apparatus of claim 1, wherein the at least one program is configured to calculate the exponential moving average by applying a preset weight ratio to the reception latency and the previously calculated exponential moving average.

3. The apparatus of claim 2, wherein the at least one program is configured to calculate the timeout value from a sum of an average of exponential moving averages received from congress nodes of the blockchain system and a standard deviation of the exponential moving averages.

4. The apparatus of claim 1, wherein the at least one program is configured to measure the reception latency of the message by starting and stopping a timer for each consensus stage in the consensus protocol.

5. The apparatus of claim 4, wherein the at least one program is configured to:
allow a chair node to measure reception latencies of a delegate request message and a commit message, and
allow a congress node to measure reception latencies of a prepare message and a committed message.

6. The apparatus of claim 1, wherein the at least one program is configured to deliver a candidate block, together with the timeout value, to all congress nodes through a prepare message and generate a final block through a commit message.

7. The apparatus of claim 1, wherein the at least one program is configured to share an exponential moving average calculated for each consensus stage in the consensus protocol among congress members, and update the timeout value at each preset block period.

8. A method for setting message reception timeout for distributed consensus, performed by an apparatus for setting message reception timeout for distributed consensus, the method comprising:
measuring reception latency of a message for each consensus stage in a consensus protocol of a blockchain system;
calculating an exponential moving average using the measured reception latency and a previously calculated exponential moving average;
calculating a timeout value for the reception latency based on the exponential moving average; and
distributing the calculated timeout value to all nodes.

9. The method of claim 8, wherein calculating the exponential moving average comprises:
calculating the exponential moving average by applying a preset weight ratio to the reception latency and the previously calculated exponential moving average.

10. The method of claim 8, wherein calculating the timeout value comprises:
calculating the timeout value from a sum of an average of exponential moving averages received from congress nodes of the blockchain system and a standard deviation of the exponential moving averages.

11. The method of claim 8, wherein measuring the reception latency comprises:
measuring the reception latency of the message by starting and stopping a timer for each consensus stage in the consensus protocol.

12. The method of claim 11, wherein measuring the reception latency further comprises:
measuring, by a chair node, reception latencies of a delegate request message and a commit message; and
measuring, by a congress node, reception latencies of a prepare message and a committed message.

13. The method of claim 8, wherein distributing the calculated timeout value comprises:
delivering a candidate block, together with the timeout value, to all congress nodes through a prepare message and generating a final block through a commit message.

14. The method of claim 8, wherein distributing the calculated timeout value comprises:
sharing an exponential moving average calculated for each consensus stage in the consensus protocol among congress members, and updating the timeout value at each preset block period.
